(19) United States
(12) Patent Application Publication
(10) Pub. No.: US 2009/0212722 A1
(43) Pub. Date: Aug. 27, 2009

(54) ADAPTIVE RV CHASSIS TAIL LAMP AND TOW LAMP CONFIGURATION

(75) Inventors: Kelvin Fraser Milne, Greenville, OH (US); Peet Pelser, Winchester, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/254,035

(22) Filed: Oct. 20, 2008

Related U.S. Application Data
(60) Provisional application No. 60/981,967, filed on Oct. 23, 2007.

(51) Int. Cl. H05B 39/00; H05B 37/02

(52) U.S. Cl. 315/314; 315/362

(57) ABSTRACT

The adaptive RV chassis tail lamp and tow lamp configuration allows switching between American and European style tail and tow lamp configurations through use of a preprogrammed chassis control module, which is simply accessed via an user interface. Further, the configuration of the tail lamps of a vehicle being towed by the RV can be configured separately from the configuration of the RV chassis tail lamps, in like manner. Still further, diagnostics may be run to determine functionality of all tail and tow lamps powered by the vehicle power distribution source.

### FIELD OF THE INVENTION

The present invention relates to an adaptive RV chassis tail lamp and tow lamp configuration.

More specifically, the configuration may be simply switched between American and European schemas through use of a user interface in communication with a chassis control module, rather than be limited to one or the other configuration due to hardwiring, as called for previously. Further, the configuration of the tail lamps of a vehicle being towed by the RV can be configured separately from the configuration of the RV chassis tail lamps, in like manner. Still further, diagnostics may be run to determine functionality of all tail and tow lamps powered by the vehicle power distribution source.

### BACKGROUND

Heretofore an RV chassis has been hardwired in either an American or European tail and tow lamp configuration, with no option being presented to switch between the two, as needed. Also, the configuration of lamps of a vehicle being towed by an RV has been necessarily an identical configuration of that of the RV chassis.

The adaptive RV chassis tail lamp and tow lamp configuration of the present invention provides a variety of options in these regards through use of an user interface, in communication with a chassis control module, as has not been previously proposed. Also, it has not been previously proposed to use such configuration for tail lamp diagnostics.

### SUMMARY OF THE INVENTION

According to the invention there is provided an adaptive RV chassis tail lamp and tow lamp configuration, which allows switching between American and European style tail and tow lamp configurations through use of a preprogrammed chassis control module which is simply accessed via a user interface. Further, the configuration of the tail lamps of a vehicle being towed by the RV can be configured separately from the configuration of the RV chassis tail lamps, in like manner. Still further, diagnostics may be run to determine functionality of all tail and tow lamps powered by the vehicle power distribution source.

### BRIEF DESCRIPTIONS OF THE DRAWINGS

FIG. 1 is a schematic block diagram of the prior art configuration, wherein all lamps are hardwired and cannot be adapted.

FIG. 2 is a schematic block diagram of the adaptive tail lamp and tow lamp configuration of the present invention, showing accommodation of American and/or European lamp configuration in either the RV chassis and/or trailer being towed thereby through use of a chassis control module providing selective input and output control schema, selected via an instrument cluster panel suitably engaged to the chassis control module.

FIGS. 3-8 are very detailed schematic circuit diagrams showing a significant portion of the complex circuitry entailed in the configuration of the present invention, as related to simplified FIG. 2.

FIG. 9 is a logic flow diagram of the logic used in the CCM with respect to control of the RV chassis tail lamp configuration.

FIG. 10 is a logic flow diagram of the logic used in the CCM with respect to control of the towed vehicle tail lamp configuration.

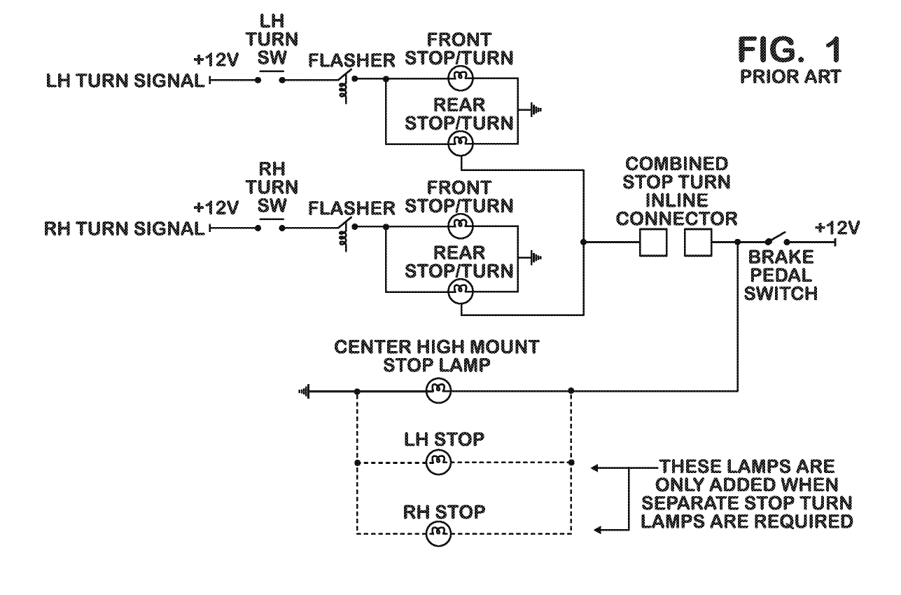

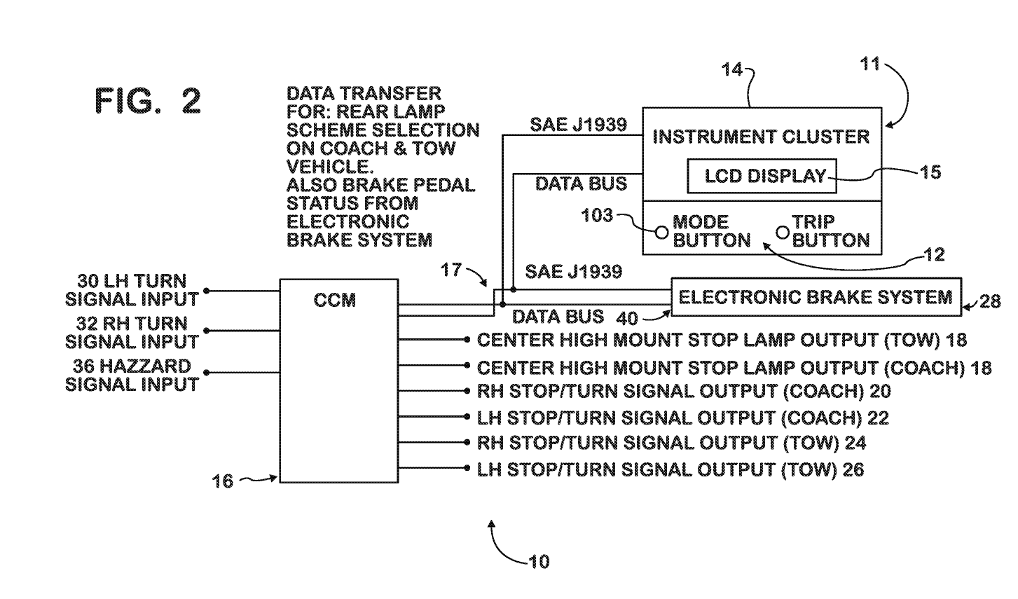

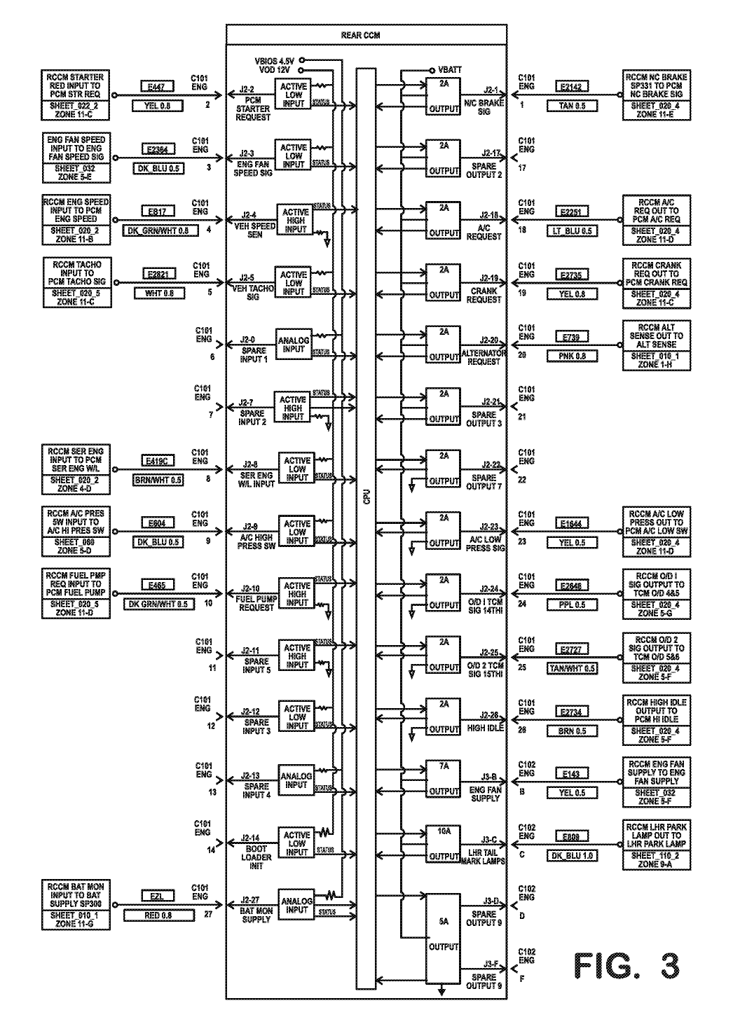

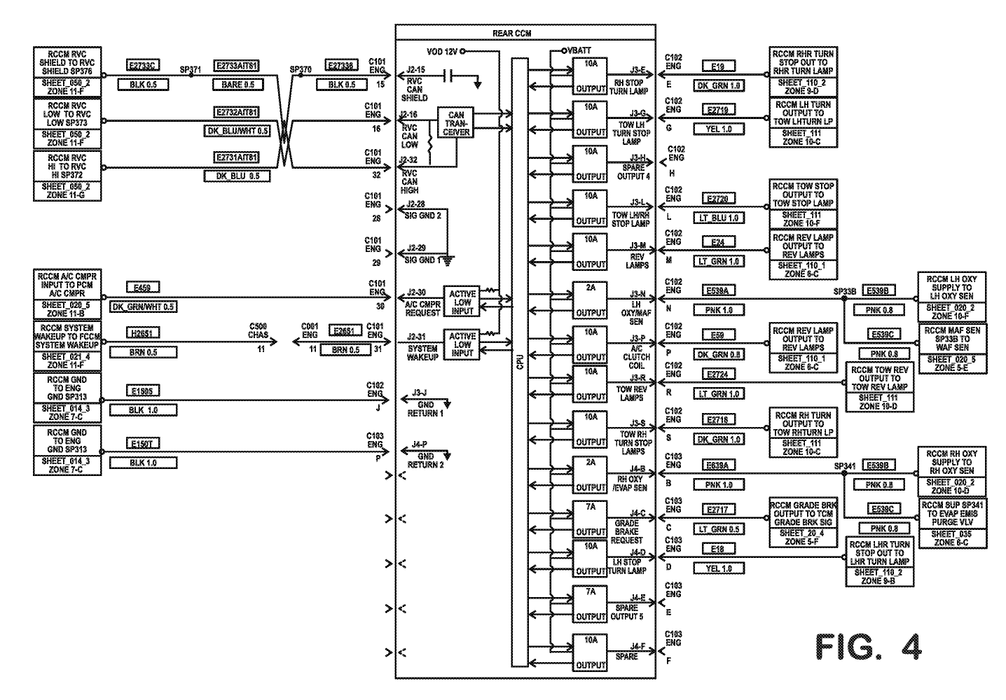

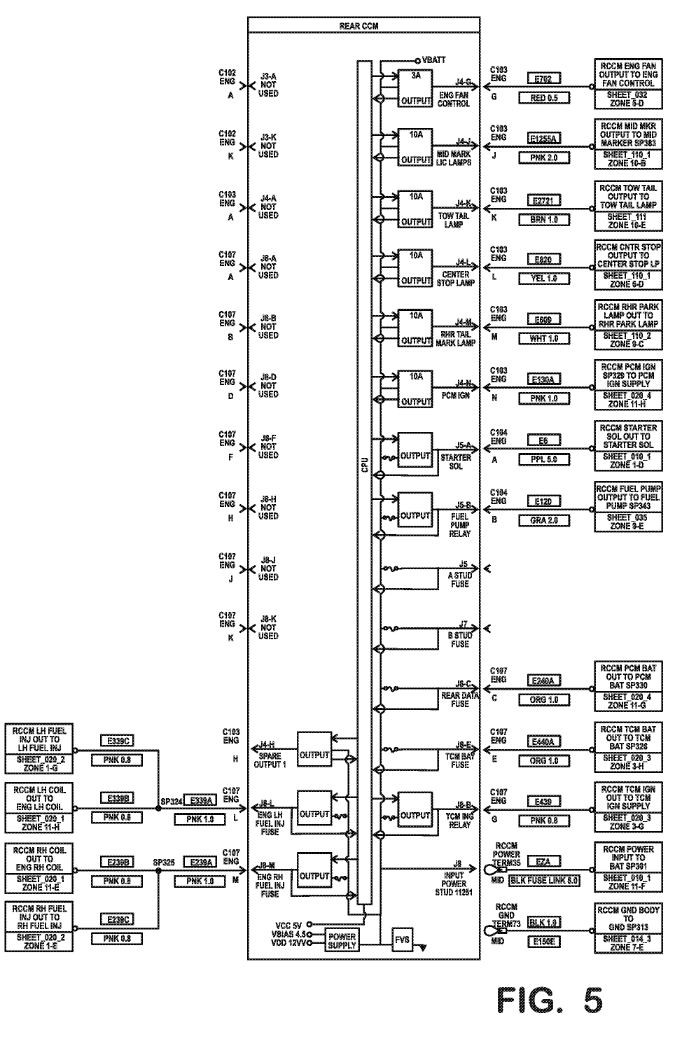

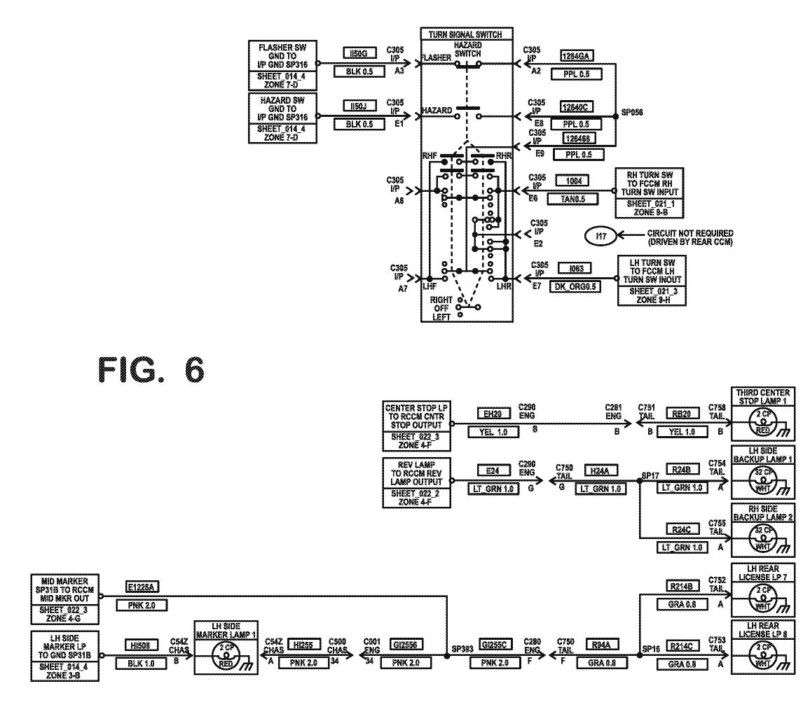

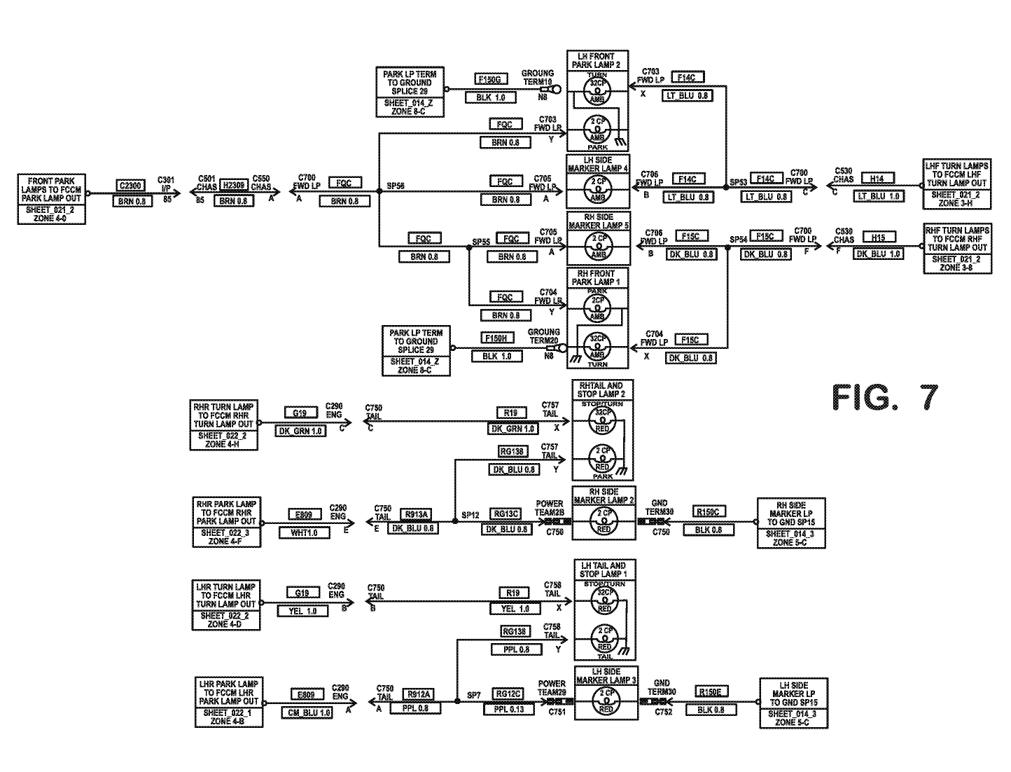

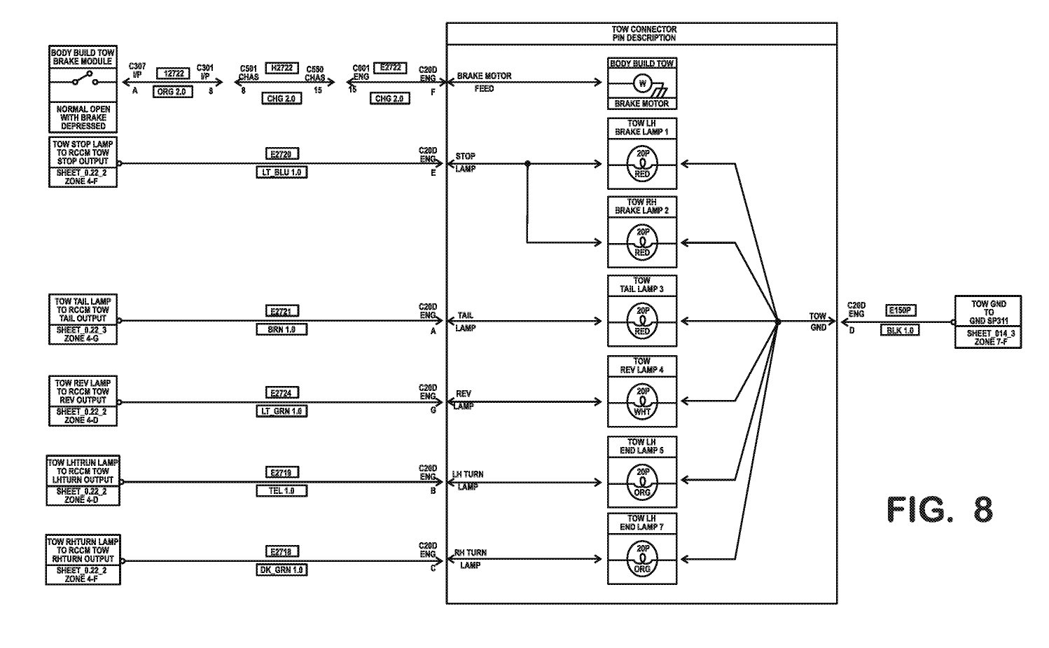

### DESCRIPTION OF THE PREFERRED EMBODIMENT

As previously stated the adaptive RV chassis tail lamp and tow lamp configuration 10 of the present invention provides a user interface 11, in the form of mode selection 12 in an instrument cluster 14 including an LCD display 15 connected to a chassis control module (CCM) 16 via a data bus 17 with an option to configure the rear lighting system for combined stop and turn lamps or separate stop and turn lamps, as illustrated. A coach body builder can now connect the rear lighting configuration for combined stop and turn lamps including control of operation of a CHMSL (center high mount stop lamp) 18. The coach can then be configured for combined stop and turn using the instrument cluster menu (not shown) of the user interface 11 for adapting to desired vehicle settings, i.e., American or European. In such user menu there is now provided an option to configure the coach lamp 20 and 22 and/or the tow lamp 24 and 26 style. Selecting coach lamp 20, 22 style on the interface 11 brings up a sub menu with the option to select separate or combined stop/turn lamps 20-26 of the American or European style, respectively.

When selecting a separate stop/turn style, the CHMSL lamp 18 is then used to power all the brake lamp circuits 28 and the turn lamps are discreetly powered by left and right turn lamp input circuits 30 and 32, respectively. RV chassis designs include a tow lamp connector on a rear lamp harness (not shown). The tow lamp style 24, 26 can be configured independently, and can be different to the coach lamp style 20, 22, if so desired.

The lamp loads are controlled by the CCM 16, which is, in a preferred embodiment, a programmable electronic module, such as a CCM made by Megatech Electro, a Teleflex Company, of 90 28^{th} Street, P.O. Box 861 Grand-Mere (Quebec) Canada G9T 5Z8, sold under assembly part no. E01827 and/or E01830, used to perform power distribution to various loads on the RV chassis. The CCM 16 communicates with the instrument cluster 14 of the user interface 11 in order to configure the coach and tow lamp styles 20, 22 and 24, 26, respectively. Before configuring the coach lamp style 20, 22 the user is required to turn on the ignition without starting the engine, turn on the hazard lamps 36 and depress the brake pedal (not shown) of the electronic brake system 40 connected to the CCM 16 via data bus 17. This procedure was put in place to prevent a user from inadvertently changing the stop/turn lamp styles 20, 22 and 24, 26. Usually, once a coach body builder has configured the stop/turn lamp style 20, 22 it would never need to be changed again, although it is possible to reconfigure multiple times. The tow stop/turn lamp style 24, 26 may also be changed multiple times. It may not be required to turn on the hazard lamps 36 and depress the brake pedal (not shown) of the electronic brake system 40 to change the tow stop/turn lamp style 24, 26.

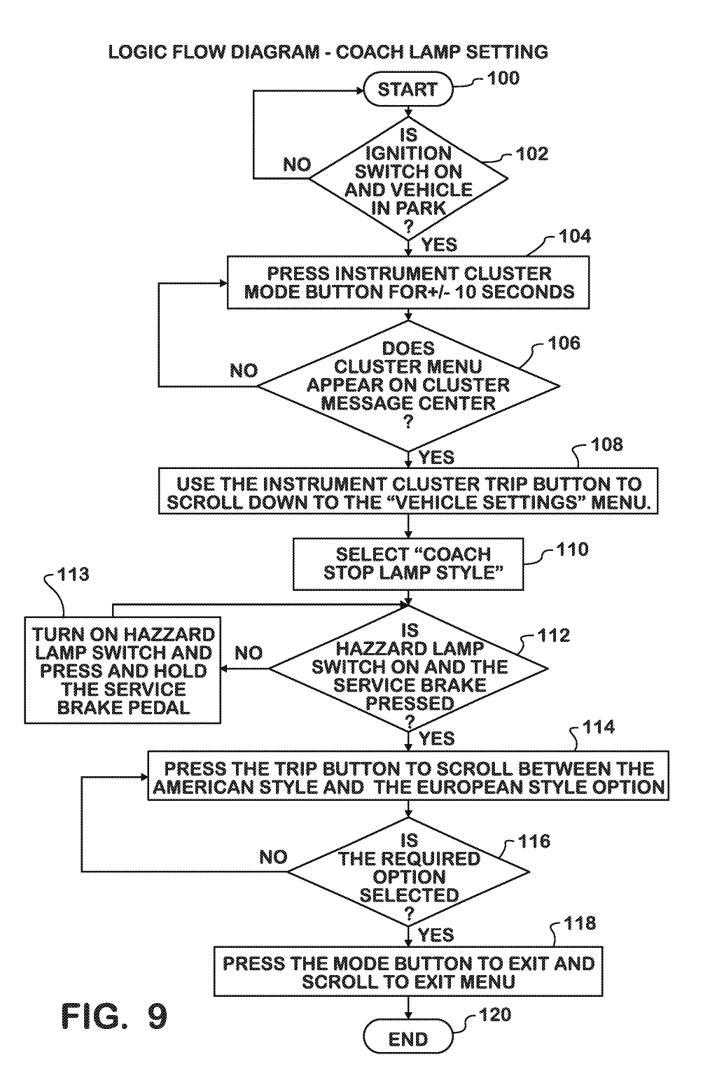

Turning now to FIG. 9, wherein a logic flow diagram is presented of the inner algorithmic workings of the CCM, we begin with step 100, wherein the logic starts up. Upon startup 100, the logic first looks to see if the ignition switch is on (no start), and checks to see if the vehicle is in park, at 102. If yes, a mode button 103 of the instrument cluster 14 is pressed for a predefined period of time. If no, the logic loops back to 100. When the instrument cluster mode button 103 is depressed correctly at 104, the logic next looks to see if a menu appears on the LCD display or message center 15 of the instrument cluster 14 at 106. If no, the logic loops back to 104 and if yes, the logic then looks for the use of a trip button to scroll down to a vehicle settings submenu, at 108. The user then selects “coach stop lamp style” at 110. Next the logic looks to see if the hazard lamp switch is on, and if the service brake is depressed, at 112. If not, it loops back to 110 until such is accomplished at 113, and when so accomplished, it continues with the user being allowed to select between European and American style lamp configuration, at 114. Next, it is determined if the required option is selected at 116, if no it loops back to step 114. If yes, the user is prompted to press the mode button 103 again and scroll to the exit menu at 118, with the program terminating thereafter at 120.

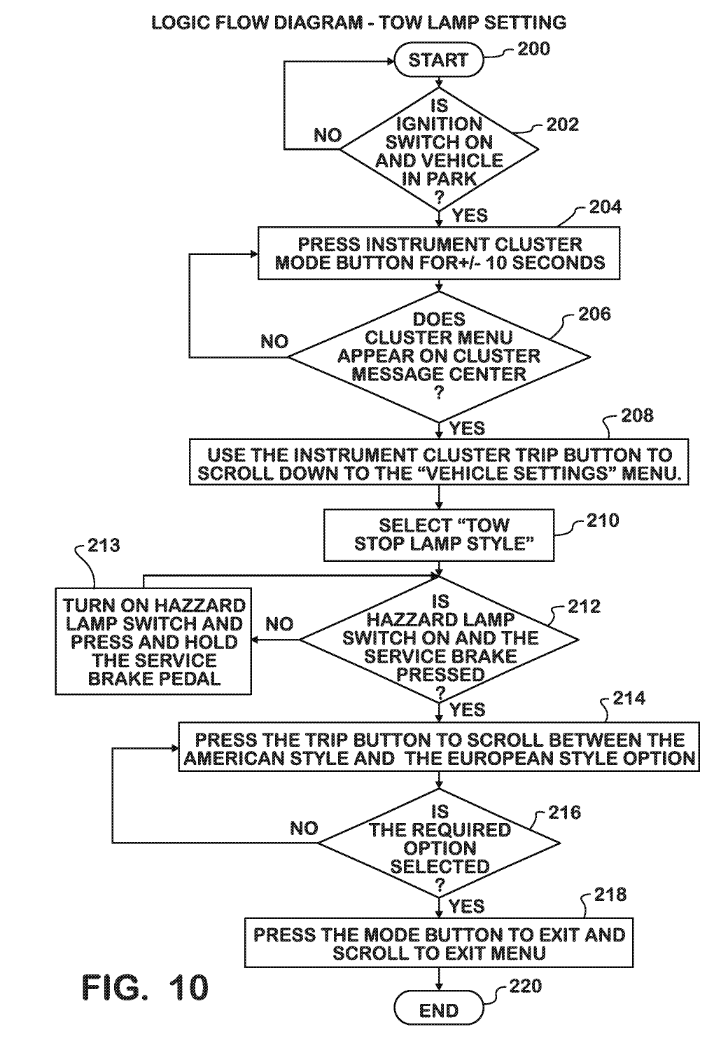

Turning now to FIG. 10, there is set forth therein a simplified logic flow diagram for setting of the lamps of a vehicle being towed by the RV chassis, into the proper style, starting at step 200. Again, at 202, the logic checks to see if the ignition switch is on (no start), and checks to see if the vehicle is in park. If yes, a mode button 103 of the instrument cluster 14 is pressed for a predefined period of time. If no, the logic loops back to 200. When the instrument cluster mode button 103 is depressed correctly at 204, the logic looks to see if a menu appears on the LCD display, or message center, 15 of the instrument cluster 14, at 206. If no, the logic loops back to 204 and if yes, the logic then looks for the use of a trip button to scroll down to a vehicle settings submenu, at 208. The user then selects “tow stop lamp style” at 210. Next the logic looks to see if the hazard lamp switch is on, and if the service brake is depressed, at 212. If not, it loops back to 210 until such is accomplished at 213, and when so accomplished, it continues with the user being allowed to select between European and American style lamp configuration, at 214. Next, it is determined if the required option is selected at 216, if no it loops back to step 214. If yes, the user is prompted to press the mode button 103 again and scroll to the exit menu at 218, with the program terminating thereafter at 220.

As described above, the configuration of the present invention provides a number of advantages, some of which have been described above and others of which are inherent in the invention. Also, modifications may be proposed without departing from the teachings herein.

We claim:

1. A vehicle for operation on the ground, comprising:
a chassis;
a wiring harness attached to said chassis;
at least one chassis tail-lamp connected to said wiring harness and receiving electrical signals from said wiring harness;
a towed-vehicle electrical connection connected to said wiring harness and receiving electrical signals from said wiring harness;
a chassis control module attached to said wiring harness, said chassis control module controlling said electrical signals sent from said wiring harness to said at least one chassis tail-lamp and to said towed-vehicle electrical connection;
a user interface connected to said chassis control module; and
electronic logic residing upon said chassis control module, said electronic logic being responsive to said user interface, and being operable to cause said chassis control module to cause said wiring harness to output electrical signals to said at least one chassis tail-lamp and to said towed-vehicle electrical connection, said electrical signals being selectable between American tail-lamp configuration and European tail-lamp configuration.

2. The vehicle for operation on the ground of claim 1, wherein:
said electronic logic being capable of causing said chassis control module to cause said wiring harness to output electrical signals to said at least one chassis tail-lamp in one configuration, and at the same time causing said chassis control module to cause said wiring harness to output electrical signals to said towed-vehicle electrical connection in another configuration.

3. The vehicle for operation on the ground of claim 2, wherein:
said chassis being further provided with an instrument panel, said user interface being an LCD display, said LCD display being integrated with said instrument panel.

4. The vehicle for operation on the ground of claim 2, wherein:
said chassis being further provided with an engine having an ignition switch, said ignition switch being connected to said wiring harness;
said chassis further having hazard lamps connected to said wiring harness and being controlled by a hazard lamp switch, said hazard lamp switch being connected to said wiring harness;
said chassis further having a brake pedal, said brake pedal activating a brake indication switch when depressed, said brake indication switch being connected to said wiring harness; and
said electronic logic being operable to allow selection of said tail-lamp configuration of said electrical signals sent to said at least one chassis tail-lamp only upon activation of said ignition switch, activation of said hazard lamp switch, and activation of said brake indication switch via depression of said brake pedal.

5. The vehicle for operation on the ground of claim 4, wherein:
said electronic logic being operable to allow selection of said tail-lamp configuration of said electrical signals sent to said at least one chassis tail-lamp only upon sequential activation of said ignition switch, then said hazard lamp switch, and then said brake indication switch via depression of said brake pedal.

6. The vehicle for operation on the ground of claim 4, wherein:
said chassis being further provided with a transmission, said transmission having a parking gear and a parking gear indication switch, said parking gear indication switch being connected to said wiring harness;
said user interface being provided with a first button and a second button;
said electronic logic operating in a sequence of steps, said sequence of steps commencing with a first step, wherein said electronic logic determines if said ignition switch is on and if said parking gear indication switch indicates that said transmission is in said parking gear;
said electronic logic operating to take a second step if said ignition switch is on and if said parking gear indication switch indicates that said transmission is in said parking gear, wherein said electronic logic determines if said first button is depressed for a period of time, otherwise if said first button is not depressed for a period of time said electronic logic returning to said first step;
said electronic logic operating to take a third step if said first button is depressed for a period of time, wherein said electronic logic causes said user interface to display a menu, said menu having as a choice a vehicle settings submenu, said vehicle settings submenu having as a choice a set coach stop lamp style selection, said first button and said second button being cooperatively operable to choose said vehicle setting submenu and then said set coach stop lamp style selection;
said electronic logic operating to take a fourth step if said first button and said second button are operated to choose said vehicle setting submenu and said set coach stop lamp style selection, wherein said electronic logic determines if said hazard lamp switch is in an on position and said brake indication switch is activated via depression of said brake pedal, otherwise if said hazard lamp switch is not in an on position or said brake indication switch is not activated said electronic logic operating to cause said menu to return to said vehicle settings submenu; and
said electronic logic operating to take a fifth step if said hazard lamp switch is in an on position and said brake indication switch is activated via depression of said brake pedal and said first button and said second button are operated to choose said set coach stop lamp style selection, wherein said electronic logic causes said user interface to allow selection between said American tail-lamp configuration and said European tail-lamp configuration of said electrical signals output by said wiring harness to said at least one chassis tail-lamp.

7. The vehicle for operation on the ground of claim 6, wherein:
said electronic logic operating to take a sixth step following said selection between said American tail-lamp configuration and said European tail-lamp configuration of said electrical signals output by said wiring harness to said at least one chassis tail-lamp, wherein said electronic logic runs a diagnostic routine to determine if said at least one chassis tail-lamp is functioning correctly.

8. The vehicle for operation on the ground of claim 2, wherein:
said chassis being further provided with an engine having an ignition switch, said ignition switch being connected to said wiring harness;
said chassis further having hazard lamps connected to said wiring harness and being controlled by a hazard lamp switch, said hazard lamp switch being connected to said wiring harness;
said chassis further having a brake pedal, said brake pedal activating a brake indication switch when depressed, said brake indication switch being connected to said wiring harness; and
said electronic logic being operable to allow selection of said tail-lamp configuration of said electrical signals sent to said towed-vehicle electrical connection only upon activation of said ignition switch, activation of said hazard lamp switch, and activation of said brake indication switch via depression of said brake pedal.

9. The vehicle for operation on the ground of claim 8, wherein:
said electronic logic being operable to allow selection of said tail-lamp configuration of said electrical signals sent to said towed-vehicle electrical connection only upon sequential activation of said ignition switch, then said hazard lamp switch, and then said brake indication switch via depression of said brake pedal.

10. The vehicle for operation on the ground of claim 8, wherein:
said chassis being further provided with a transmission, said transmission having a parking gear and a parking gear indication switch, said parking gear indication switch being connected to said wiring harness;
said user interface being provided with a first button and a second button;
said electronic logic operating in a sequence of steps, said sequence of steps commencing with a first step, wherein said electronic logic determines if said ignition switch is on and if said parking gear indication switch indicates that said transmission is in said parking gear;
said electronic logic operating to take a second step if said ignition switch is on and if said parking gear indication switch indicates that said transmission is in said parking gear, wherein said electronic logic determines if said first button is depressed for a period of time, otherwise if said first button is not depressed for a period of time said electronic logic returning to said first step;
said electronic logic operating to take a third step if said first button is depressed for a period of time, wherein said electronic logic causes said user interface to display a menu, said menu having as a choice a vehicle settings submenu, said vehicle settings submenu having as a choice a set towed-vehicle stop lamp style selection, said first button and said second button being cooperatively operable to choose said vehicle setting submenu and then said set towed-vehicle stop lamp style selection;
said electronic logic operating to take a fourth step if said first button and said second button are operated to choose said vehicle setting submenu and said set towed-vehicle stop lamp style selection, wherein said electronic logic determines if said hazard lamp switch is in an on position and said brake indication switch is activated via depression of said brake pedal, otherwise if said hazard lamp switch is not in an on position or said brake indication switch is not activated said electronic logic operating to cause said menu to return to said vehicle settings submenu; and
said electronic logic operating to take a fifth step if said hazard lamp switch is in an on position and said brake indication switch is activated via depression of said brake pedal and said first button and said second button are operated to choose said set towed-vehicle stop lamp style selection, wherein said electronic logic causes said user interface to allow selection between said American tail-lamp configuration and said European tail-lamp configuration of said electrical signals output by said wiring harness to said towed-vehicle electrical connection.

11. The vehicle for operation on the ground of claim 10, wherein:
said electronic logic operating to take a sixth step following said selection between said American tail-lamp configuration and said European tail-lamp configuration of said electrical signals output by said wiring harness to said towed-vehicle electrical connection, wherein said electronic logic runs a diagnostic routine to determine if said towed-vehicle electrical connection is functioning correctly.

12. The vehicle for operation on the ground of claim 2, wherein:
said chassis being further provided with an engine having an ignition switch, said ignition switch being connected to said wiring harness; and
said electronic logic being operable to allow selection of said tail-lamp configuration of said electrical signals sent to said towed-vehicle electrical connection only upon activation of said ignition switch.

13. The vehicle for operation on the ground of claim 12, wherein:
said chassis being further provided with a transmission, said transmission having a parking gear and a parking gear indication switch, said parking gear indication switch being connected to said wiring harness;
said user interface being provided with a first button and a second button;
said electronic logic operating in a sequence of steps, said sequence of steps commencing with a first step, wherein said electronic logic determines if said ignition switch is on and if said parking gear indication switch indicates that said transmission is in said parking gear;
said electronic logic operating to take a second step if said ignition switch is on and if said parking gear indication switch indicates that said transmission is in said parking gear, wherein said electronic logic determines if said first button is depressed for a period of time, otherwise if said first button is not depressed for a period of time said electronic logic returning to said first step;
said electronic logic operating to take a third step if said first button is depressed for a period of time, wherein said electronic logic causes said user interface to display a menu, said menu having as a choice a vehicle settings submenu, said vehicle settings submenu having as a choice a set towed-vehicle stop lamp style selection, said first button and said second button being cooperatively operable to choose said vehicle setting submenu and then said set towed-vehicle stop lamp style selection;
said electronic logic operating to take a fourth step if said first button and said second button are operated to choose said set towed-vehicle stop lamp style selection, wherein said electronic logic causes said user interface to allow selection between said American tail-lamp configuration and said European tail-lamp configuration of said electrical signals output by said wiring harness to said towed-vehicle electrical connection.

14. The vehicle for operation on the ground of claim 13, wherein:
said electronic logic operating to take a fifth step following said selection between said American tail-lamp configuration and said European tail-lamp configuration of said electrical signals output by said wiring harness to said towed-vehicle electrical connection, wherein said electronic logic runs a diagnostic routine to determine if said towed-vehicle electrical connection is functioning correctly.
